(19) United States
(12) Patent Application Publication
(10) Pub. No.: US 2005/0253073 A1
(43) Pub. Date: Nov. 17, 2005

(54) Gamma ray detector for positron emission tomography (pet) and single photon emisson computed tomography (spect)

(76) Inventors: Christian Joram, Crozet (FR); Jaques Seguinot, Gex (FR); Peter Weilhammer, Commugny (CH)

Correspondence Address: SUTHERLAND ASBILL & BRENNAN LLP, 999 PEACHTREE STREET, N.E., ATLANTA, GA, 30309, US

(21) Appl. No.: 10/521,221

(22) PCT Filed: Jul. 17, 2002
(86) PCT No.: PCT/EP02/07967

§ 371 Date: May 27, 2005

(51) Int. Cl. G01T 1/164

(52) U.S. Cl. 250/363.03; 250/367; 250/366

(57) ABSTRACT

The invention relates to a detector module (1) for a Positron Emission Tomograph (PET) and for Single Photon Emission Computed Tomography (SPECT) comprising a matrix (3) of scintillator crystals, said matrix having a first side and a second side opposite to said first side, each scintillator crystal having a first end (14) and a second end (15), said scintillator crystals (2) being oriented parallel to each other, whereby said first end (14) and said second end (15) of each of said scintillator crystals (2) coincide with said first side and said second side of said matrix (3), respectively; a first light sensitive detector (6) producing electrical signal proportional to the amount of light detected, being optically connected to said first side of said matrix (3), said first light sensitive detector (6) being position sensitive; and a second light sensitive detector (7) producing electrical signal proportional to the amount of light detected, said second light sensitive detector (7) being optically connected to said second side of said matrix (3), wherein said second light sensitive detector (7) is positioned sensitive. Using said detector module (1) a method to determine the 3D-coordinates of a point of interaction of a gamma quantum (γ1, γ2) with said detector module (1) is disclosed method. This allows to use signals from compton seattered γ's to enhance the sensitivity of a Positron Emission Tomograph scanner provided being composed of said detection modules (1) without parallax errors.

The invention relates to position and energy sensitive gamma ray detectors and a method to determine the points of interaction of gamma rays with such gamma ray detectors, particularly to gamma ray detectors for Positron Emission Tomography (PET) and Single Photo Emission Computed Tomography (SPECT).

### BACKGROUND OF THE INVENTION

In recent years Positron Emission Tomographs (PET) have become an increasingly important diagnostic tool in medicine as well as in biology.

Positron Emission Tomographs provide quantitative measurements on the metabolism of internal organs and their biochemistry by in vivo measuring specific activities of positron emitting radio-nuclides. The most commonly used radio-nuclide is the isotope ¹⁸F in fluorodeoxyglucose (FDG). Over the last 20 years a continuous development of PET scanners have demonstrated a tremendous potential for cancer diagnosis and treatment.

Conventional PET systems in use for medical application employ gamma detectors consisting of several stacked rings of scintillator crystals to obtain a volumetric image. In 2D PET designs the rings are separated by tungsten septa to suppress Compton scattered photons coming from other parts of the body. Only coincidences of opposite crystals within the ring or neighbored rings are recorded. In 3D designs the septa are suppressed to increase the detection efficiency and coincidences of crystals from all rings are registered.

In the conventional PET systems, scintillator crystals, usually BGO (Bismuth Germanate) blocks of 2″×2″ cross section are radially oriented and read out by four standard 1″ photomultiplier tubes (PMT). These photomultiplier tubes are not position sensitive. More recently also LSO (Lutetium Oxyorthosilicate)crystals have been used. The radial length of the crystals corresponds to about three attenuation lengths, leading to a probability of interaction of 95% of the gamma quanta of 511 keV. In some designs equidistant crossed slots segment the scintillator blocks over a large fraction of their length into sub-crystals. This results in a better resolution of the projected photo-conversion point from the interpolated charge signals of the photomultiplier tubes. The radial coordinate, i.e. the depth of interaction, is however not determined, leading to a degraded reconstruction precision due to parallax errors.

The parallax error problem, inherent to the above described detected geometry, has recently been addressed in several developments:

In a first approach called PHOSWICH (or sometimes PHOSWITCH) two or more blocks of different scintillator material with different delay time constant are piled up in radial direction. The time information, i.e. the width of the signal, is converted into a radial coordinate. Nevertheless the resolution achievable for the radial coordinate is still poor. For conventional PET in use a full width at half maximum (FWHM) parallax error of 15 mm is known. For new developments not yet implemented beyond proof of principle FWHM of 6 to 15 mm has been disclosed (J. S. Huber, W. W. Moses, M. S. Andreaco and O. Petterson, IEEE proceedigs 2000).

A different approach uses detector stacks of several layers of 2D photon detectors to give a 3D device. Yet another approach uses the asymmetry in the light detected on two opposite sides of the crystal to determine the point of interaction within a crystal to arrive at the radial coordinate. Detectors according to the last approach given have been built using a matrix of LSO crystals readout on one side by an array of PIN photodiodes and on the opposite side by conventional photomultiplier tube (PMT). Other types of detector combinations on both sides of the crystal matrix have been used. However, all of these combinations exhibits intrinsic limitations such as pixel size, number of pixels, surface coverage, energy resolution, gain uniformity, which compromise the final performance of the PET scanner or its individual detector modules.

### INVENTION

It is an object of the present invention to provide an improved gamma ray detector, particularly for Positron Emission Tomography (PET) and Single Photo Emission Computed Tomography (SPECT), with improved sensitivity and improved spatial resolution for reducing or eliminating parallax errors in Positron Emission Tomography and as second detector in a SPECT Compton camera with improved spatial resolution and negligible parallax error.

According to a first aspect of the invention a detector module for a Positron Emission Tomograph (PET) is provided, said detector module comprising a matrix of scintillator crystals, said matrix having a first side and a second side opposite to said first side, each scintillator crystal having a first end and a second end, said scintillator crystals being oriented parallel to each other, whereby said first end and said second end of each of said scintillator crystals coincide with said first side and said second side of said matrix, respectively; a first light sensitive detector producing an electrical signal proportional to the amount of light detected, being optically connected to said first side of said matrix, said first light sensitive detector being position sensitive; and a second light sensitive detector producing an electrical signal proportional to the amount of light detected, said second light sensitive detector being optically connected to said second side of said matrix characterized in that said second light sensitive detector is position sensitive.

The disclosed detector module offers the capability to reconstruct the point of interaction of a gamma ray with said detector module in 3D-space with high precision. Furthermore, the point of interaction for gamma photons undergoing a Compton scattering prior to a photo effect absorption within the detector module can be determined at a similar precision. Thereby the total sensitivity of said detector modules is enhanced.

According to a second aspect of the invention a Positron Emission Tomograph (PET) scanner comprising a number of gamma detector modules is disclosed, whereby said gamma detector modules each comprise a detector module comprising a matrix of scintillator crystals, each scintillator crystal having a first and a second end, said scintillator crystals being oriented parallel to each other such that all midpoints of said scintillator crystals lie in one plane; a first light sensitive detector and a second light sensitive detector, each of said light sensitive detectors produces an output signal proportional to the amount of light detected and is position sensitive; said number of gamma detector modules are regularly angularly spaced on a first and a second circle around an axis of said scanner and oriented such, that all midpoints of said scintillator crystals of said detector modules lie in a symmetry plane perpendicular to said axis, whereby the spacing and distribution of said detector modules on said first and said second circle is such, that there is practically a full azimuthal coverage.

A Positron Emission Tomograph scanner according to the present invention is superior to Positron Emission Tomograph scanners of the art in that it provides a parallax free reconstruction of the point of gamma ray emission within the scanner. Further the sensitivity of the scanner is drastically increased by the fact, that events can be used in the reconstruction of the gamma ray emission process, in which one or both gamma rays being produced in the annihilation undergo a Compton scattering in one of said detector modules prior to being absorbed by photo. effect in said one of said detector modules. The present invention discloses a compact Positron Emission Tomograph (PET) scanner that can be build cost effectively.

According to a third aspect of the invention a method for detecting the point of interaction of a gamma ray within a detector module is provided, said method comprising a matrix of scintillator crystals, each scintillator crystal having a first end and a second end, said scintillator crystals being oriented parallel to each other such that all midpoints of said scintillator crystals lie in a plane; a first light sensitive detector and a second light sensitive detector, each of said light sensitive detectors produces an output signal proportional to the amount of light detected and is position sensitive; said detector module having a coordinate system associated with, whereby two linear independent coordinate axis x and y span a xy-plane coinciding with said plane defined by said midpoints of said scintillator crystals and a third coordinate axis z is oriented perpendicular to said plane, whereby an origin of the coordinate system lies in the xy-plane and a positive direction of the coordinate axis z points to said first light sensitive detector, said method comprising the steps determining the coordinates of said point of interaction in said xy-plane by identifying a first scintillator crystal being hit and using the known coordinates of said first scintillator crystal being hit in said xy-plain; determining the coordinate of said point of interaction in said direction perpendicular to said xy-plane by determining an amount of charge Q1 detected in said first light sensitive detector and an amount of charge Q2 detected in said second light sensitive detector within a coincidence time interval, where the coordinate z is given by z=1/2·[λ(lnQ₁−lnQ₂)+L], where L is the length of said scintillator crystal hit along a direction of said coordinate z.

This method enables one to determine the point of interaction of a gamma ray within a gamma detector very precisely in all three coordinates of a three dimensional coordinate system. The determination of the point of interaction does not involve difficult or time consuming calculations. Therefore the determination of the point of interaction is fast which offers the possibility to use this method in detectors being exposed to high count rates.

According to a fourth aspect of the invention a Single Photon Emission Computed Tomography (SPECT) detector is disclosed comprising a photon detector in which said photon detector is a detector module for a Positron Emission Tomograph according to aspect one of the invention.

A SPECT detector according to the present invention offers a greatly enhanced resolution and sensitivity over detectors of the prior art.

According to a fifth aspect of the invention a Hybrid Photo Diode (HPD) detector is provided, comprising a vacuum containment, said vacuum containment having a flat entrance window at a top and a base at a bottom opposite to said top; a semi-transparent visible light bialkali photocathode deposited inside the vacuum containment at said top parallel to said entrance window, a semiconductor sensor mounted inside the vacuum containment on said base, said semiconductor sensor comprising segments; a self-triggering electronic circuitry for reading out each of said segments separately, being mounted inside said vacuum containment at said base; an electron optic providing a 1:1 imaging of charge particles from said semi-transparent visible light bialkali-photocathode onto said semiconductor sensor.

The Hybrid Photo Diodes detector according to the invention exhibits a light sensitive detector with very good linearity with respect to the amount of light detected as well as a very good position sensitivity of the light impinging on its entrance window. By including the triggering electronic circuits within the vacuum containment a low noise read out is provided. The HPD detector according to the invention is especially suited for coincidence detection schemes due to the fact that each segment can be read out separately and that the triggering electronics are self-triggering.

### DRAWINGS

Exemplary embodiments of the invention are illustrated in the drawings and are explained in more detail in the following description.

In the figures:

FIG. 1a shows a schematic top view of an embodiment of a detector module for a PET;

FIG. 1b is a schematic representation of a side view of the detector module for a PET according to FIG. 1a,

FIG. 2 is a schematic drawing of a Hybrid Photo Diodes (HPD) detector;

FIG. 3 is a graph displaying the energy of a Compton scattered photon versus the scattering angle;

FIG. 4 is a three-dimensional graph of the cross section for a Compton scattered photon has a function of the initial photon energy and the scattering angle according to the Klein-Nishina-formnula;

FIG. 5 illustrates a schematic view of a sector of an embodiment of a PET ring scanner.

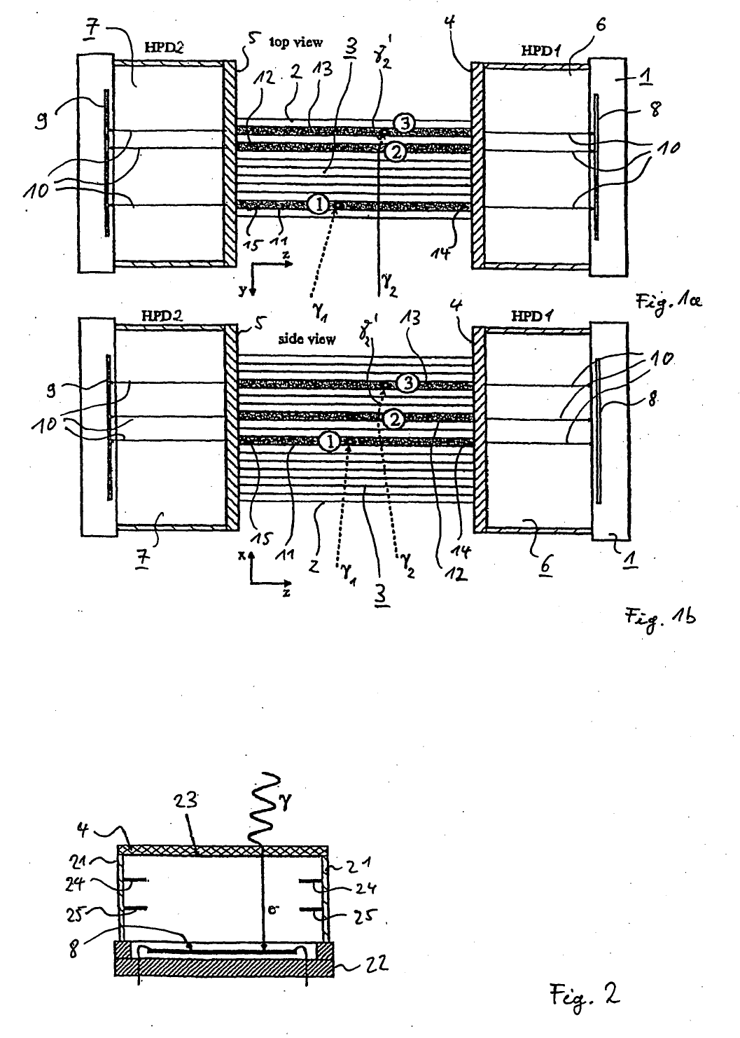

FIG. 1a displays a top view of a schematic drawing of a detector module 1 according to the invention. Said detector module 1 comprises scintillator crystals 2 arranged in a regular matrix 3. The scintillator crystals 2 are of longitudinal shape. The preferred dimensions of each of said scintillator crystals 2 are: 3.2×3.2×100 mm³. Said scintillator crystals 2 of 100 mm length can be made by joining two or three shorter scintillator crystal segments with a glue of an appropriate refractive index. All surfaces of said scintillator crystals 2 are polished. The scintillator crystals 2 are equally spaced in said regular matrix 3. A preferred gap between each of said scintillator crystals 2 is 0.8 mm. Said gaps between said crystals 2 allow the insertion of blinds, for example, black paper, to prevent light being transferred from one of said crystals 2 to another of said crystals 2. Said scintillator crystals 2 are oriented parallel to each other and such, that midpoint of said scintillator crystals 2 are all lying in a plane.

Gamma rays γ₁, γ₂ interacting with said scintillator crystals 2 by photo effect (γ₁) or by Compton scattering (γ₂) create photons in said scintillator crystals 2. The number of photons produced in such an interaction is proportional to the amount of energy deposited in said scintillator crystals 2. The wave length of the photons created in said scintillator crystals 2 is usually in the visible spectral range. Preferred scintillator crystal materials are Cerium doped Yttrium Aluminum Perovskite (YAP:Ce) and Cerium doped Lutetium Oxyorthosilicate (LSO:Ce). Both materials have very good physical characteristics. LSO:Ce has the advantage of a larger effective atomic number Z=65 which leads to a higher probability for gamnma conversion by photoelectric effect and therefore to a better detection efficiency. YAP:Ce crystals are easier to fabricate and therefore cheaper to manufacture or buy. The physical properties of YAP:Ce crystals are shown in table 1. Another preferred crystal material is LuAP:Ce.

TABLE 1
Main characteristics of YAP:Ce scintillating crystals

| | |
|---|---|
| Density ρ (g/cm³) | 5.55 |
| Effective atomic charge Z | 32 |
| Scintillation light output (photons/MeV) | 18000 |
| Wavelength of max. emission (nm) | 370 |
| Refractive index n at 370 NM | 1.94 |
| Bulk light absorption length L_{α} (cm) at 370 NM | 14 |
| Principal decay time (Ns) | 27 |
| mean γ attenuation length at 511 keV (mm) | 22.4 |
| mean γ absorption length at 511 keV (mm) | 60.5 |

The light produced by the interaction of said gamma rays γ₁, γ₂ with said scintillator crystals 2 propagates through the scintillator crystals 2 by total internal reflection from said polished surfaces of said scintillator crystals 2. Said visible light produced in the interaction of said gamma rays γ₁, γ₂ with said scintillator crystals 2 propagates through said scintillator crystals 2 towards entrance windows 4, 5 of a first and a second light sensitive detectors 6, 7. The solid angle of light accepted, which is determined by the pair of refractive indices at interfaces between said scintillator crystals 2 and said entrance windows 4, 5 of said lights sensitive detectors 6, 7 is 40% of 4 π towards both sides. The ends of the crystals can be polished in a spherical shape resulting in a light focussing affect.

Photons passing through said entrance windows 4, 5 of said light sensitive detectors 6, 7 are transformed into electrons in the photocathode. These electrons are accelerated at 12 keV and imaged in a 1:1 imaging onto position sentsitive semiconductor sensors 8, 9 as is indicated by arrows 10. Said semiconductor sensors 8, 9 are energy sensitive, i.e., the signal produced is proportional to the amount of detected charge created in the said sensors pteferably made of Si. The exact setup and function of said light sensitive detectors 6, 7 will be described with reference to FIG. 2 below.

It is preferred to choose the number of crystals in said matrix 3 in combination with the dimensions of said scintillator crystals 2 such that the total length of material along one direction denoted, for exunple, by y amounts to about three times the attenuation lenigth for photons of a preferred photon energy to be detected. For a Positron Emission Tomograph detector this preferred gamma photon energy is 511 keV. Referring to the characteristics given in table 1, above, and said preferred scintillator crystal 2 dimensions of 3.2×3.2×100 mm³ said matrix 3 comprises eight layers of crystals 2 along said y direction. As exhibited in FIG. 1b a preferred embodiment of said detector module 1 comprises 18 layers of crystals 2 along a direction x perpendicular to said y direction. The matrix 3 can contain any suitable number of crystals 2 depending on their dimensions. The matrix 3 can also be stonewall patterned.

Whereas gamma ray γ₁ undergoes a photo effect upon interaction with a first scintillator crystal 11 of said scintillator crystals 2 and produces light only within said first scintillator crystal 11 the gamma ray γ₂ first interacts with a second scehtillator crystal 12 of said scintillator crystal 2 undergoing a Compton scattering prior to being absorbed by a photoelectric effect within a third scintillator crystal 13 of said scinitllator crystals 2. Therefore, one receives for the conversion of a gamma ray by photoelectric effect light in one of said scintillator crystals 2, for cxample in said first scintillator crystal 11. For a gamma ray γ₂ undergoing a Compton scattering prior to a photoelectric effect conversion one yields light in two different scintillator crystals 2 for example in said second scintillator crystal 12 and said third scintillator crystal 13 of said scintillator crystals 2.

FIG. 2 illustrates a schemiatic drawing for a light sensitive detector according to the invention. Such a light sensitivc detector is also called Hybrid Photo Diodes (HPD) detector. Said light senisitive detector 6 comprises a vacuurn envelope or containment, comprising an entrance window 4 at the top, side walls 21, and a base 22 at the bottom. The entrmce window 4 is preferably made of sapphire. The base comprises a ceramics printed circuit. Inside said vacuum containment parallel to said entrantce window 4 at the top a semi-transparent visible light bialkali photocathode 23 is deposited. The semi-transparent visible light bialkali photocathode 23 exhibits a quantum efficiency of about 25% at a wavelength of 370 nm. Within the vacuum containment an electron optics is contained for “proximity focussing”, i.e., a 1:1 imaging of the photon pattern on said photocathode 33 onto a semiconductor sensor 8 disposed on said base 22. The electron optic comprises ring electrodes 24, 25.

The semicoanductor sensor 8 is a silicon sensor. The silicon sensor 8 is segmented into individual diodes of dimensions matching the pattern of said crystal matrix 3 according to FIG. 1a, 1b. A potential difference between said semi-transparent visible light bialkali photocathode 23 and said semiconductor sensor 8 determines the amount of electron-hole pairs created in the bulk of the silicon sensor by one photoelectron impinging on said silicon sensor 8. A preferred potential difference of about 12 keV leads to the creation of about 3000 electronhole pairs. In other words, the internal gain of the light sensitive detector 6 at 12 keV is about 3000. The point spread function, which describes the Gaussian width of the charge distribution on said semiconductor sensor 8 for a point like light source, is of the order of 0.3 mm for. Therefore, a segmentation of the diodes with dimensions 4×4 mm² is a preferred segmentation to match the pattern of the crystal matrix with crystals of the dimension 3.2×3.2×100 mm³. It is essential that at least one diode corresponds to each of said crystals 2 in said matrix 3 according to FIG. 1a, 1b. For the embodiment described herein, the precise spacing of the crystals is insured by 0.8 mm thick stainless steel wires (not displayed) which are strung between the crystals close to said two sides of said matrix 3.

Within said vacuum containment self triggering electronics are mounted on said base 22. It is possible to use the VLSI chip VATA-GP produced in 0.6 μAMS CMOS Technology for said semiconductor sensor 8. Each of the 128 channels of this chip has a charge integrating preamplifier, a shaper with a tunable shaping time τₛ=150±50 ns and a readout register. A parallel fast shaper circuit (τₛ=35 ns) produces a trigger signal for the read out logic. The chip features also a sparse readout option which allows to achieve event rates in the order of 100 kHz. The single photon detection efficiency of said light sensitive detector 6 with this electronics is expected to be 93%.

The matrix 3 of scintillator crystals 2 and the two light sensitive detectors 6, 7 form a detector module 1 which is protected by a thin cover (not displayed) against external light.

In the following section the method for reconstruction the point of interaction of a gamma ray within said detector module 1 of FIG. 1a, 1b will be described. First the determination of the point of interaction for a gamma ray γ₁ undergoing a photoelectric effect conversion will be treated. The coordinates in an xy-plane are derived from the address of said first scintillator crystal 11 of said scintillator crystals 2. Said xy-plane is the plane defined by all midpoints of said scintillator crystals 2 of said detector module 1. The resolutions σₓ, σ_{y} are in first approximation determined by the dimensions of said scintillator crystals 2:

$${σ}_{x} = {σ}_{y} = \frac{s}{\sqrt{12}} \qquad ( 1 )$$

with s being the size of said scintillator crystals along said x direction and said y direction in said xy-plane.

In the embodiment described s=3.2 mm. The spatial resolution of said light sensitive detectors 6, 7 being Hybrid Photo Diodes (HPD) detectors is matched to this value of said scintillator crystal luminance and will not contribute significantly. Hence the x and y coordinate of the point of interaction of the gamma ray γ₁ with said detector module 1 can be reconstructed within a precision of better than 2.2 mm (FWHM), hence 1.5 mm for the positron annihilation point.

The bulk absorption length of 14 cm of YAP:Ce crystal for the visible scintillation light produced in the interaction of a gamma ray γ₁ with said first scintillator crystals 1 makes it possible to use long crystals of for example 100.0 mm length. At the same time said bulk absorption length is responsible for the fact, that the amount of said scintillation detected at a first end 14 of said scintillator crystal 11 depends on the distance of the point of interactive of said gamma ray γ₁ with said scintillator crystal 11 from said first end 14. Therefore, the axial coordinate z in a direction perpendicular to said xy-plane is derived from the ratio of amount of light (=charge) detected at said first end 14 and a second end 15 of said first scintillator crystal 11 being hit. The z-coordinate is given by

$$z = \frac{1}{2} [ λln \frac{{Q}_{1}}{{Q}_{2}} + L ] \qquad ( 2 )$$

taking an exponential absorption of the light in the scintillor. L is the length of the crystal being hit. λ denotes the bulk absorption length. Q₁ is the charge detected at said first end 14 of said first scintillator crystal 11 being hit and Q₂ is the amount of charge detected at said second end 15 of said first scintillator crystal 11 being hit. Although the light produced as a result of said first gamma ray γ₁ undergoing a photoelectric absorption in said first scintillator crystal 11 is nearly isotropic with respect to the initial direction of propagation the amount of light detected at said first end 14 and said second end 15 of said first scintillator crystal 11 being hit differ due to the bulk light absorption of said first scintillator crystal 11.

By error propagation the precision σ_{z} is derived as

$$\begin{matrix}{σ}_{z} = {\frac{λ}{2} [ \frac{1}{{Q}_{1}} + \frac{1}{{Q}_{2}} ]}^{\frac{1}{2}} = \frac{λ}{\sqrt{2 Q}} \sqrt{{ⅇ}^{\frac{L - z}{λ}} + {ⅇ}^{\frac{z}{λ}}} and & ( 3 ) \\ Q = {Q}_{1} + {Q}_{2} & ( 4 )\end{matrix}$$

To achieve a spatial resolution in the z-coordinate of about 4 mm FWHM the light attenuation length in the scintillator has to be tuned to a value of 50 to 75 mm by adjustment of the Ce doping.

The total amount of charge 2 detected by said first light sensitive detector 6 and said second light sensitive detector 7 can be used to discriminate events induced by photoelectric conversion of a 511 keV gamma ray from events stemming from gamma rays with different photon energies or from Compton scattering events of 511 keV gamma. I.e. only events where the total amount of charge Q corresponds to the charge normally deposited by a 511 keV gamma ray during a photoelectric conversion are assumed to be valid points of interaction.

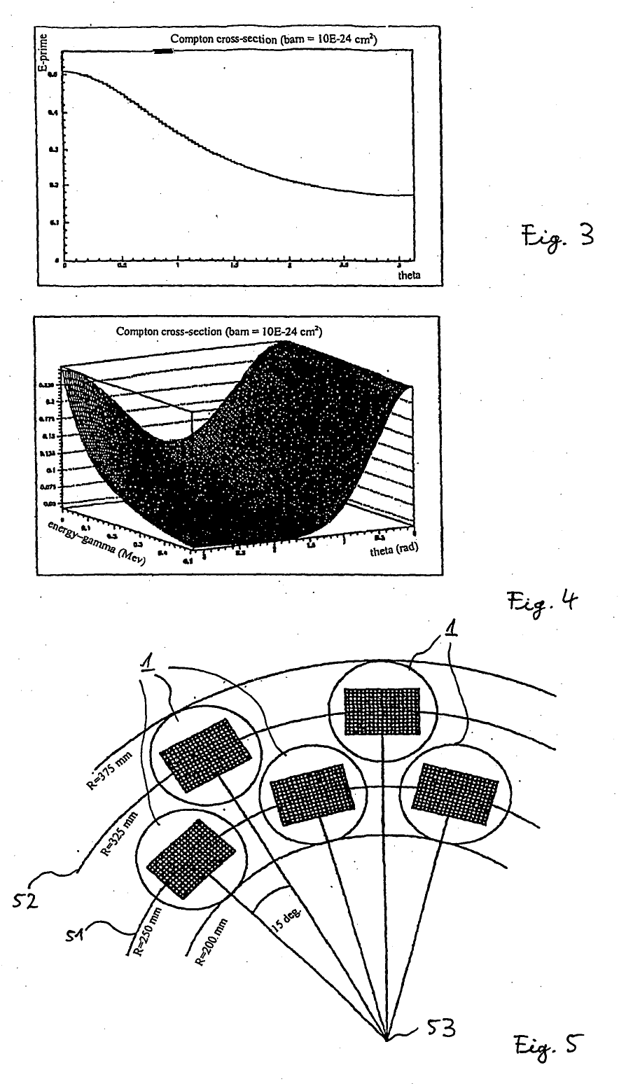

Next it will be described how the point of interaction of a gamma ray with said detector module 1 first undergoing Compton scattering prior to undergoing a photoelectric-conversion can be determined. Gamma ray γ₂ undergoes a Compton scattering in said second scintihator crystal 12. In the scattering process the gamma ray deposits a variable amount of energy in said second scintillator crystal 12 and changes its direction of propagation. FIG. 3 illustrates the Compton kinematics. The energy of the scattered photon verses the scattering angle (rad) is displayed. As can be inferred from FIG. 3, the incoming gamma ray γ₂ can be scattered into the full solid angle. FIG. 4 displays the Compton scattering cross section γ₂ as a function of the initial photon energy and the scattering angle. The scattered photon interacts with said third scintillator crystal 13 by photoelectric-conversion. In order to differentiate between the Compton scattering process and the photo conversion process it is necessary to eliminate all processes in which said gamma ray γ₂ is not scattered into a forward hemisphere. A details analysis shows that a Compton scattering angle can be restricted to 0≦θ≦60° (i.e. to scattering process into said forward hemisphere), if the energy deposit in the first interaction, seen from the origin, where the gamma ray γ₂ originates from, i.e. in said second scintiulator crystal 12, is below 170 keV (for a gamma ray of 511 keV). 60% of all event fall in this category.

In a Positron Emission Tomograph scanner system the origin of the gamma ray γ₂ is to be determined. Therefore, the point of interaction of the Compton scattering process is the one of interest. The determination of the coordinates of the point of interaction of the gamma ray γ₂ with said second scintillator crystal 12 is performed as described above for the photoelectric-conversion process. Regarding the validity of these coordinates extra requirements have to be met. First the total amount of charge Q=Q₁+Q₂ detected for said second scintillator crystal 12 must correspond to an energy deposition of less than 170 keV (for a γ of 511 keV). Second another scintillator crystal of said scintillator crystals 2 has to be been hit, i.e. the third scintillator crystal 13 has to be been hit. Since the scattered gamma ray γ₂ is propagating with the speed of light the signals from said second scintillator crystal 12 and said third scintillator crystal 13 are detected simultaneously, i.e. within a coincidence interval. Third the amount or charge detected from said third scintillator crystal 13 needs to amount to the energy difference between the energy of the gamma ray γ₂ (511 keV) and the energy deposited by the Compton scattering process in said second scintillator crystal 12. The fourth requirement is that the third scintillator crystal 13 is distanced further from the origin of the original gamma ray γ₂ than said second scintillator crystal 12, i.e. in a Positron Emission Tomograph scanner as described below said second scintillator crystal 12 needs to be closer to a center of said Positron Emission Tomograph scanner than said third scintillator crystal 13. In case all these four requirements are satisfied at the same time, the coordinates deternined in said second scintillator crystal 12 in which the Compton scattering process took place are regarded as valid coordinates.

FIG. 5 shows a section of an axial view of a Positron Emission Tomograph ring scanner of 40 cm in a diameter. In total 24 detector modules 1 (of which 5 are shown) are arranged alternating on a first circle 51 and a second circle 52 being concentric to an axis 53 perpendicular to the plane of drawing. This total number of 24 detector modules 1 is required to provide a full crack free coverage of the circumference. The individual detector modules 1 are oriented such that the scintillator crystals 2 are parallel to said axis 53. Further all midpoints of said scintillator crystals 2 lie within a plane perpendicular to said axis 53. At axis 53 coincides with the z directions of the coordinate systems being associated with each of said detector modules 1. The y directions of said coordinate systems being associated with each of said detector modules 1 each point in a radial direction outward from said axis 53.

Due to the large length of said scintillator crystals 2 (10 cm) the PET ring scanner according to FIG. 5 has a large Axial Field of View (AFOV).

The advantage of this Positron Emission Tomograph (PET) scanner is that the origin of the two. gamma quanta emerging from the annihilation process of a positron with an electron can be reconstructed without a parallax error. This is due to the fact that the point of interaction of both of said gamma quanta can be determined with a high precision in all 3D-coordinates. Furthermore, the ability of said detector modules 1 to determine the point of interaction for events in which a Compton scattering happens prior to the photoelectric conversion increases the detection probability drastically. For detector modules made with YAP:Ce crystals, as described above the detection probability for the photoelectric conversion of a 511 keV gamma ray is only ε_{γ}^{photo}=4%. Hence the probability to convert both of said gamma quanta each having 511 keV by photoelectric effect is low [symbol] (ε_{y}^{photo})² [symbol] . The gamma reconstruction in full 3D and the large detection volume allow however to take into account a substantial fraction of events which underwent Compton scattering as mentioned above. The total energy is reconstructed by summing up the energy to all of said scintillator crystals 2 hit. To unambiguously distinguish between the coordinate of the primary Compton interaction (the one to be used in the tomographical reconstruction algorithm) and the coordinate of the final absorption of the scattered photon γ₂ one has to restrict to events in which the photon is scattered into the forward hemisphere, as has been pointed out before. The criterion for this forward hemisphere scattering is, that the energy deposit in the first interaction seen from the center of the Positron Emission Tomograph (PET) scanner is below 170 keV for a 511 keV gamma ray. As 60% of all events fall into this category the detection probability of one gamma ray involving both Compton and photoelectric effect is hence
ε_{y}^{Compton}=0.6·ε_{y}^{photo}=2.4% (5)

The probability ε_{y}^{CE} of the coincident Compton enhanced detection of two 511 keV gamma quanta becomes

$$\begin{matrix}{ɛ}_{γ}^{CE} = 2 \cdot {ɛ}_{γ}^{compton} \cdot {ɛ}_{γ}^{photo} + {( {ɛ}_{γ}^{compton} )}^{2} + {( {ɛ}_{γ}^{photo} )}^{2} \\ = 2 \cdot ( 0.6 \cdot {ɛ}_{γ}^{photo} ) \cdot {ɛ}_{γ}^{photo} + {( 0.6 \cdot {ɛ}_{γ}^{photo} )}^{2} + {( {ɛ}_{γ}^{photo} )}^{2} \\ = 0.41 \%\end{matrix} \qquad ( 6 )$$

Therefore, the sensitivity is improved roughly by a factor

$$\frac{{ɛ}_{γ}^{CE}}{{( {ɛ}_{γ}^{photo} )}^{2}} = 2 , 6 \qquad ( 7 )$$

For crystal material with higher effective Z (e.g. LSO) the detection probability for the photoelectric conversion of 511 keV gamma ray is higher, and consequently the sensitivity improvement using Compton scattered events will be smaller than a factor 2.6. This enhancement can be considered as conservative estimate, since the increase of the photo-conversion probability at low gamma energies (E_{y}<511 keV) has been neglected.

For a Positron Emission Tomograph (PET) detector an enhanced signal to noise ratio is provided. The PET scanner is equipped with a read out logic which requires to orthogonal modules to fire within a coincidence time of τ_{MS}=10 ns which is defmed by the monostables of the VATA-GP3 chips used in the Hybrid Photo Diodes (HPD) detectors described above. A random coincidence rate N_{F} is given by
N_{F}=2τ_{MS}·N₁·N₂ (8)
where N_{1,2} are counting rates of two opposite detector modules 1. Requiring less than 1% random coincidences and assuming N₁=N₂=N limits the counting rate of one of said opposite detector modules 1 to 500 kHz. Taking into account the solid angle defined by one detector module (ΔΩ/4π=0.87%) this translates to maximum activity Aₘₐₓ of the positron source

$${A}_{max} = \frac{N}{ΔΩ} = 57 MBq = 1.55 mCi \qquad ( 9 )$$

which is comparable to the activity regulated by the international protocols for PET imaging. However as a result of the Compton enhanced reconstruction a better signal to noise ratio for the same activity or, in other words, a PET image with higher contrast is achieved.

Finally several performance considerations regarding the detector modules shall be discussed.

The total number of detected photons N_{det} detected at both ends, said first end 14 and said second end 15, of said first scintillator crystal 11 hit by a gamma ray is

$${N}_{det} = {N}_{ph} {ɛ}_{c} \cdot {ɛ}_{Q} ( {ⅇ}^{- \frac{z}{{L}_{a}}} + {ⅇ}^{- \frac{L - z}{{L}_{a}}} ) , \qquad ( 10 )$$

where the number of generated scintillation photons Nₚₕ, following the absorption of a 511 keV gamma quantum, is 0.511 MeV·18.000 MeV⁻¹=9200, the light transport efficiency ε_{c}, ignoring bulk absorption, is 0.8 over the whole length of the crystal, a quantum efficiency ε_{Q} at the wavelength 355 nm is 0.25, λ denoted the bulk absorption length, and z is the distance of the interaction point measured from one of said first end 14 and said second end 15 of said scintillator crystal 11 with total length L.

Restricting to gamma reconstruction by photoelectric effect only, for a 511 keV gamma one finds

$${N}_{det} = 1560 \cdot ( {ⅇ}^{- \frac{z}{λ}} + {ⅇ}^{- \frac{L - z}{λ}} ) , \qquad ( 11 )$$

For an attenuation length of λ=75 mm N_{det} varies from 795 photons at z=50 mm to N_{det}=980 for γ hit at z=0.

The energy resolution R=ΔE_{FWHM}/E is the quadratic convolution of three sources
R=R_{Sci}⊕Rₛₜₐₜ⊕Rₙₒᵢₛₑ (12).

The intrinsic resolution R_{Sci} of the scintillator crystal due to material inhomogeneity, coupling between scintillator crystal and light sensitive detector and non-linear energy response has been measured to be 2.5%.

Rₛₜₐₜ represents the statistical fluctuation involved in the light generation and detection process, including the light sensitive detectors 6, 7. Rₛₜₐₜ=2.35/\sqrt{N_{det}}. The single stage dissipative gain mechanism for the Hybrid Photo Diodes (HPD) operated at 12 kV leads to a negligible contribution to Rₛₜₐₜ.

Also the electronic Rₙₒᵢₛₑ of the detection chain is very small compared to the other two terms.

In summary, the energy resolution is nearly independent of the axial coordinate (z coordinate) and can be approximated by

$$R \approx {R}_{stat} = \frac{2.35}{\sqrt{{N}_{det}}} \approx 8 \% \cdot \sqrt{\frac{511}{{E}_{γ} ( keV )}} \qquad ( 13 )$$

hence R≈8% (FWHM at E_{γ}=511 keV and ≈18% at E_{γ}=100 keV.

The electronic noise of the VATA-GP electronics is of the order of 500 e⁻ ENC (Equivalent Noise Charge). A dynamic range of a Hybrid Photo Diodes (HPD) electronic read out chain has to be 80. This is driven by

the expected maximum number of photons: ca.≈1000 for the conversion of a gamma quantum with 511 keV energy close to one of said firt and said second ends of said scinfillator crystals 2;

and the detection threshold of the fast triggering circuit used for the timing: a threshold corresponding to five photons is assumed, which is equivalent to an energy deposition of 6.4 keV or 15.000 e⁻ created in said semiconductor sensors 8, 9 made of silicon. The detection threshold of 15.000 e⁻ provides very comfortable and clean working conditions as it is a factor 30 above the electronics noise. The time walk of the fast trigger circuit between a gamma quantum at 511 keV (1000 photons) and a gamma quantum at 50 keV (200 photons) can be estimated in first approximation:

$$Δ t = {N}_{thr}^{ph} \cdot {τ}_{peak} ( \frac{1}{{N}_{511 keV}^{ph}} - \frac{1}{{N}_{50 keV}^{ph}} ) , \qquad ( 14 )$$

with a peaking time τₚₑₐₖ of 35 ns at time walk At of less than 4 ns is detected, which is comparable to classical photomultiplier tube (PMT) based systems.

In conclusion the segmentation of the detector volume in small scintillator crystals and the matched segmentation of said semiconductor sensors of said HPD provide the required resolution in said xy-plane. The z coordinate is derived with high precision from the asymmetry of the amounts of light detected at said ends of said scintillator crystals 2. Hence the interaction of a gamma ray γ₁, γ₂ is reconstructed in full 3D without any parallax error irrespective of the 511 keV gamma emission point.

The high light output of the scintillating crystals 2 combined with the excellent energy resolution of the HPD detectors results in a good energy measurement required for background discrimination. The short decay time constant of the scintillation light and the fast triggering output of the HPD readout electronics allow to define short coincidence intervals, which further reduces accidental background. The combination of 3D reconstruction of the gamma interaction point with the good energy resolution and the large detection volume provides another unique feature: in addition to the reconstruction of gammas by photoelectric effect, also a significant fraction of events which undergo single Compton scattering can be detected without degraded performance. This Compton enhanced mode increases very significantly the sensitivity of a detector module 1 as well as of a Positron Emission Tomograph ring scanner.

The light sensitive detector (HPD) according to the invention includes a novel feature, which consists of double-metal silicon pad sensors combined with self-triggering front-end electronics. This concept allows to read out pixilated silicon sensors with relatively large pad dimensions, as used in the above described PET detector, at the periphery of the silicon sensor.

The HPD according to the invention uses a ceramic envelope. This allows to use a very thin sapphire or diamond window to avoid spreading of the photons over many pads.

The HPD according to the invention uses a method, a non evaporative getter chemical pump to keep the ultra high vacuum over long periods of time.

The features disclosed in the foregoing description, in the claims and/or in the accompanying drawings may, both separately and in any combination thereof, be material for realising the invention in diverse forms thereof.

1. Detector module for a Positron Emission Tomograph (PET) comprising
a matrix of scintillator crystals, said matrix having a first side and a second side opposite to said first side, each scintillator crystal having a first end and a second end, said scintillator crystals being oriented parallel to each other, whereby said first end and said second end of each of said scintillator crystals coincide with said first side and said second side of said matrix, respectively;
a first light sensitive detector producing an electrical signal proportional to the amount of light detected, being optically connected to said first side of said matrix, said first light sensitive detector (6) being position sensitive; and
a second light sensitive detector producing an electrical signal proportional to the amount of light detected, said second light sensitive detector being optically connected to said second side of said matrix, being position sensitive.

2. Detector module for a Positron Emission Tomograph (PET) according to claim 1, wherein said first light sensitive detector and said second light sensitive detector are segmented such that at least one segment in each of said light sensitive detectors corresponds to each of said scintillator crystals in said matrix.

3. Detector module for a Positron Emission Tomograph (PET) according to claim 2, wherein segmentation patterns of said light sensitive detectors match patterns of their respective matrix sides.

4. Detector module for a Positron Emission Tomograph (PET) according to claim 1, wherein said first light sensitive detector is a Hybrid Photo Diode (HPD) detector.

5. Detector module for a Positron Emission Tomograph (PET) according to claim 1, wherein said second light sensitive detector is a Hybrid Photo Diode (HPD) detector.

6. Detector module for a Positron Emission Tomograph (PET) according to claim 1, wherein said matrix has a rectangular pattern or a stonewall pattern with a first direction (y) parallel to one side of said rectangular pattern; said scintillator crystals comprise a crystal material and an added crystal material length along said first direction (y) corresponds to about three times the absorption length of photons (γ₁, γ₂) with a primary photon energy to be detected in said crystal material.

7. Detector module for a Positron Emission Tomograph (PET) according to claim 6, wherein said matrix comprises 12×18 scintillator crystals.

8. Detector module for a Positron Emission Tomograph (PET) according to claim 1, wherein said crystal material comprises Cerium doped Yttrium Aluminum Perovskite (YAP:Ce).

9. Detector module for a Positron Emission Tomograph (PET) according to claim 1, wherein said crystal material comprises Cerium doped Lutetium Oxyortho-silicate (LSO:Ce) or LuAP:Ce.

10. Detector module for a Positron, Emission Tomograph (PET) according to claim 1, wherein said scintillator crystals have the dimensions of 3.2×3.2×100 mm³.

11. Detector module for a Positron Emission Tomograph (PET) according to claim 1, wherein said scintillator crystals are spaced in said matrix by wires strung between said scintillator crystals close to said first and said second side of said matrix.

12. Detector module for a Positron Emission Tomograph (PET) according to claim 1, wherein said wires have a diameter of 0.8 mm.

13. Detector module for a Positron Emission Tomograph (PET) according to claim 10, wherein said segments of said first and said second light detector have the dimensions of 4 mm×4 mm.

14. Detector module for a Positron Emission Tomograph (PET) according to claim 1, wherein said scintillator crystals comprise crystal segments glued together with a glue having a matched refractive index as said crystal segments.

15. Positron Emission Tomograph (PET) scanner comprising a number of gamma detector modules characterized in that said gamma detector modules each comprise a detector module comprising
a matrix of scintillator crystals, each scintillator crystal having a first end and a second end, said scintillator crystals being oriented parallel to each other such that all mid points of said scintillator crystals lie in one plane;
a first light sensitive detector and a second light sensitive detector, each of said light sensitive detectors produces an output signal proportional to the amount of light detected and is position sensitive;
said number of gamma detector modules are regularly angularly spaced on a first and a second circle around an axis of said scanner and oriented such that all midpoints of said scintillator crystals of said detector modules lie in a symmetry plane perpendicular to said axis, whereby the spacing and distribution of said gamma detector modules on said first and said second circle is such that there is no line of sight in a direction perpendicular to said axis radial outward from the cross section of said axis with said symmetry plane, such that there is practically a full azimuthal coverage.

16. Positron Emission Tomograph (PET) scanner according to claim 15, wherein said angular spacing between a first one of said gamma detector modules being localized on said first circle to an adjacent second one of said gamma detector modules localized on said second circle is 15°.

17. Method for detecting the point of interaction of a gamma ray (γ₁, γ₂) within a detector module comprising
a matrix of scintillator crystals, each scintillator crystal having a first end and a second end, said scintillator crystals being oriented parallel to each other such that all mid points of said scintillator crystals lie in a plane;
a first light sensitive detector and a second light sensitive detector, each of said light sensitive detectors produces an output signal proportional to the amount of light detected and is position sensitive;
said detector module having a coordinate system associated with, whereby two linear independent coordinate axes χ and γ span a χγ-plane coinciding with said plane defined by said midpoints of said scintillator crystals and a third coordinate axis z is oriented perpendicular to said plane whereby an origin of said coordinate system lies in said Xy-plane and a positive direction of said coordinate axis z points to said first light sensitive detector (6), said method comprising the steps
determining the coordinates of said point of interaction in said Xy-plane by identifying a first scintillator crystal being hit and using the known coordinates of said first scintillator crystal being hit in said Xy-plane;
determining the coordinate of said point of interaction in said direction (z) perpendicular to said Xy-plane by determining the amount of charge Q1 detected in said first light sensitive detector and an amount of charge Q2 detected in said second light sensitive detector within a coincidence time interval, where the coordinate z is given by where L is the length of said first scintillator crystal.

18. Method for detecting the point of interaction of a gamma ray (γ₁, γ₂) within, a PET detector module according to claim 17, wherein said determined coordinate is considered to be valid, if the total amount of charge (Q L−Q2) detected by said first and said second light sensitive detectors equals a reference charge corresponding to a predetermined photon energy.

19. Method for detecting the point of interaction of a gamma ray (γ₁, γ₂) within a PET detector module according to claim 17, where the determined coordinate is considered to be valid, if the total amount of charge (Q1+Q2) detected by said first and said second light sensitive detectors originating from said first scintillator crystal hit is lower than 60% of said reference charge, corresponding to said predetermined photon energy, and a second coordinate is determined according to the method of claim 18 in a same coincidence time interval, associated with a different scintillator crystal hit and the charges detected by said first light sensitive detector and said second light sensitive detector originating from said different scintillator crystal hit are Q3 and Q4, respectively, and the total amount of charges (Q1+Q2+Q3+Q4) detected by said first light sensitive detector and said second light sensitive detector originating from said first scintillator crystal hit and said different scintillator crystal hit is about equal to said reference charge and said coordinate is closer to the source emitting the gamma ray than said second coordinate.

20. Single Photon Emission Computed Tomography detector comprising a photon detector characterized in that said photon detector is a detector module ( for a Positron Emission Tomograph according to any of the 1 to 14 claim 1.

21. Hybrid Photo Diodes (HPD) detector comprising
a vacuum containment, said vacuum containment having a flat entrance window at a top and a base at a bottom opposite to said top;
semi transparent visible light bialkali photocathode deposited inside said vacuum containment at said top parallel to said entrance window;
a semiconductor sensor mounted inside said vacuum containment on said base said semiconductor sensor comprising segments;
a self triggering electronic circuitry for reading out each of said segments separately, being mounted inside said vacuum containment at said base
an electron optic providing a imaging of photo electrons from said semi-transparent visible light bialkali photocathode onto said semiconductor sensor

22. Hybrid Photo Diodes (HPD) detector according to claim 21, wherein said base comprises a ceramic material.

23. Hybrid Photo Diodes (HPD) detector according to claim 21, wherein said semiconductor sensor is a silicon sensor.

24. Hybrid Photo Diodes (HPD) detector according to claim 21, wherein said self triggering circuitry comprises one channel for each segment of said semiconductor sensor;
a charge integrating preamplifier for each of said channels;
a shaper for each of said channels; and
a readout register for each of said channels.

25. Hybrid Photo Diodes (HPD) detector according to claim 24 wherein said shaper has a tunable shaping time.

26. Hybrid Photo Diodes (HPD) detector according to 25 claim 21, further comprising a parallel fast shaper circuit for producing a trigger signal for a readout logic.

27. Hybrid Photo Diodes (HPD) detector according to 26 claim 21, wherein said electron optics comprise any suitable number of ring electrode.

28. Hybrid Photo Diodes (HPD) detector according to claim 21, wherein said bialkali photocathode is directly deposited on the inside of said entrance window.

29. Hybrid Photo Diodes (HPD) detector according to claim 21, wherein said entrance window is comprising sapphire.
